(19) United States
(12) Patent Application Publication
(10) Pub. No.: US 2004/0186626 A1
(43) Pub. Date: Sep. 23, 2004

(54) Robot hand

(76) Inventors: Katsunori Tsukamoto, Fukuoka (JP); Satoshi Sueyoshi, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/487,223

(22) PCT Filed: Aug. 15, 2002
(86) PCT No.: PCT/JP02/08308

(30) Foreign Application Priority Data
Aug. 20, 2001 (JP) 2001-248951

(51) Int. Cl. G05B 15/00; G06F 19/00

(52) U.S. Cl. 700/258; 700/245

(57) ABSTRACT

The invention provides a robot hand, which stops a robot by detecting a collision, when the robot hand collides against a peripheral device or the like, and which absorbs the impact of the collision to reduce the occurrence of a damage due to the collision.

The robot hand (2) comprises a base (21) mounted on the leading end of a robot arm (1), and a pair of support members (22) mounted in parallel to the base (21), for placing and transferring a large-sized substrate (3) on the support members (22). Expandable/shrinkable hollow members (41) filled with a fluid are mounted to the leading ends of the support members (22).

### TECHNICAL FIELD

The present invention relates to a robot hand for transferring a large-sized substrate such as a liquid crystal glass substrate.

### BACKGROUND ART

FIG. 2 is a top plan view of a large-sized substrate transferring robot hand of the related art.

In the Figure, numeral 1 designates a robot arm; numeral 2 denotes a robot hand attached to the leading: end of the robot arm 1; and numeral 3 defines a liquid crystal glass substrate placed on the robot hand.

The robot hand 2 comprises abase 21 mounted on the robot arm 1, and a pair of support members 22 mounted in parallel to the base 21. The base 21 and the paired support members 22 form a C-shaped plane shape. The support members 22 are provided on their upper faces with the not-shown adsorptive means to adsorb and fix the liquid crystal glass substrate 3.

As the liquid crystal glass substrate is large-sized in recent years, the robot hand is also large-sized. However, the robot hand has to be handled within a limited space. As a result, a problem arises in that the robot hand collides against a peripheral device or the like and then breaks the peripheral device or the liquid crystal substrate being transferred.

### DISCLOSURE OF THE INVENTION

Therefore, it is an object of the invention to provide a robot hand, which stops a robot by detecting a collision, when the robot hand collides against a peripheral device or the like, and which absorbs the impact of the collision to reduce the occurrence of a damage due to the collision.

In order to solve the aforementioned problem, according to the invention of claim 1, there is provided a robot hand comprising a base mounted on the leading end of a robot arm, and a pair of support members mounted in parallel to the base, for placing and transferring a large-sized substrate on the support members, wherein expandable/shrinkable hollow members filled with a fluid are mounted to the leading ends of the support members. In the invention of claim 2, the robot hand further comprises a sensor for detecting the pressure of the fluid filled in the hollow members. In the invention of claim 3, moreover, the sensor is mounted in the base, and the hollow members and the sensor are coupled through pipelines built in the support members.

### BRIEF DESCRIPTION OF THE DRAWINGS

FIG. 1 is a top plan view of a robot hand showing an embodiment of the invention, and

FIG. 2 is a top plan view of a robot hand showing an example of the related art.

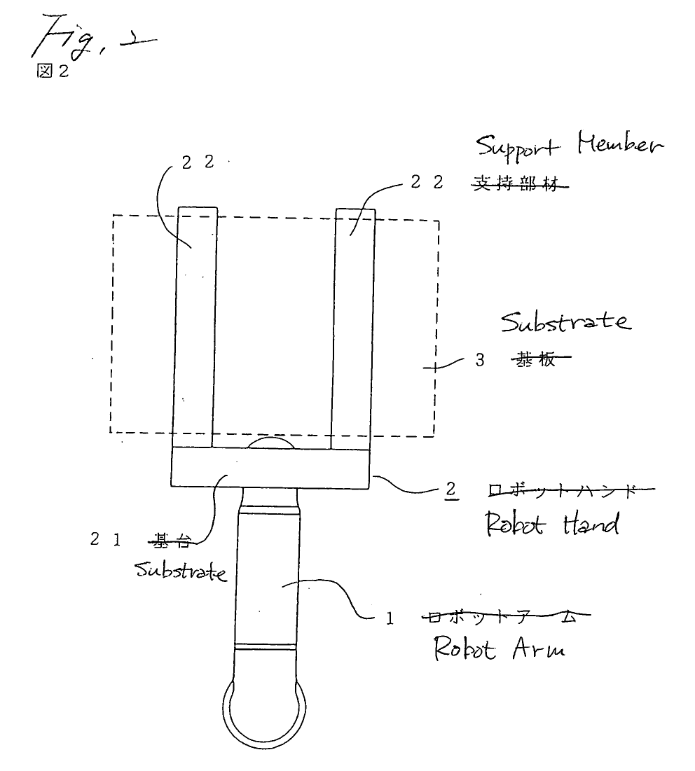

### BEST MODE FOR CARRYING OUT THE INVENTION

The embodiment of the invention will be described in the following with reference to the accompanying drawing.

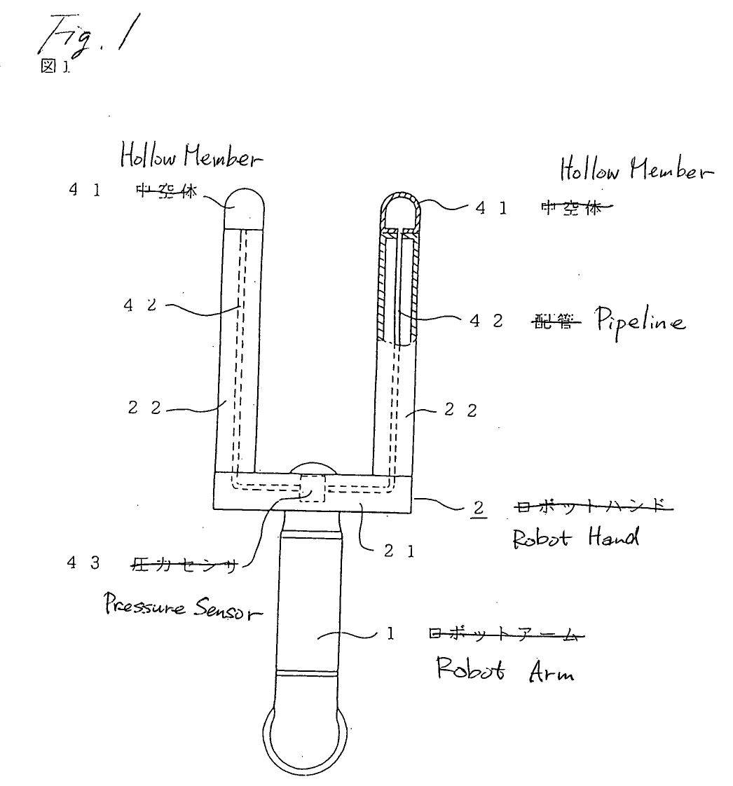

FIG. 1 is a top plan view of a robot hand showing the embodiment of the invention partially in section. The portions shared with the related art are designated by the common reference numerals so that their description is omitted.

In FIG. 1, numeral 41 designate hollow members, which are mounted to the leading ends of the support members 22. The hollow members 41 are made of expandable/shrinkable box or bag of rubber, soft synthetic resin or the like. The hollow members 41 are filled with a fluid. It is the best the fluid to be used for filling the hollow members 41 is such clean air as would not contaminate the environment even if it should leak to the outside. It is, however, arbitrary to select another gas or a liquid such as water or oil suitably for the purpose.

Numeral 42 designates pipe lines, and numeral 43 designate a pressure sensor. The pipelines 42 are vinyl pipes arranged in the support members 22 for transmitting the pressure of the fluid filled in the hollow members 41 to the pressure sensor 43. This pressure sensor 43 is mounted in the base for detecting the pressure of the fluid filled in the hollow members 41 thereby to transmit a signal indicating a rise, if any, in the pressure of the fluid to the (not-shown) control device of the robot.

Here will be described the functions of this robot hand 2. When the leading ends of the robot hand 2 come into contact with a foreign substance such as a peripheral device, the hollow members 41 are crushed to raise the pressure of the fluid filled therein. The pressure sensor 43 detects the pressure rise and sends the signal to the control device of the robot. In response to the signal, the robot control device judges that the robot hand 2 has made contact with the foreign substance, and stops the robot instantly. Moreover, the impact at the contact between the robot hand 2 and the foreign substance is absorbed by the deformation of the hollow members 41. In short, the hollow members 41 act as shock-absorbing cushions so that they can prevent the robot hand 2 and the foreign substance from being seriously damaged.

As has been described hereinbefore, the invention has an advantage that it can detect the contact between the robot hand and the foreign substance reliably with the simple mechanism. Another advantage is that the pressure sensor can be placed at a position apart from the hollow members, because the pressure sensor and the hollow members are connected through the pipelines. Still another advantage is that it is easy to design the robot hand having no interference between the pressure sensor and the object to be transferred, because the position to place the pressure sensor can be freely selected.

### Industrial Applicability

The invention is useful for the robot hand for transferring a large-sized substrate such as a liquid crystal glass substrate.

1. A robot hand comprising a base mounted on the leading end of a robot arm, and a pair of support members mounted in parallel to said base, for placing and transferring a large-sized substrate on said support members,
characterized in that expandable/shrinkable hollow members filled with a fluid are mounted to the leading ends of said support members.

2. A robot hand as set forth in claim 1,
characterized by further comprising a sensor for detecting the pressure of the fluid filled in said hollow members.

3. A robot hand as set forth in claim 2,
characterized: in that said sensor is mounted in said base; and in that said hollow members and said sensor are coupled through pipelines built in said support members.
